(19) United States
(12) Patent Application Publication
(10) Pub. No.: US 2012/0036621 A1
(43) Pub. Date: Feb. 16, 2012

(54) Electrostatic Discharge Garment

(76) Inventor: Kek Hing Kow, Ampang (MY)

(21) Appl. No.: 13/262,784

(22) PCT Filed: Apr. 2, 2009
(86) PCT No.: PCT/MY2009/000048

§ 371 Date: Nov. 3, 2011

(51) Int. Cl. A62B 17/00

(52) U.S. Cl. 2/456

(57) ABSTRACT

An electrostatic discharge garment (10) having a body (11) and a pair of sleeves (12a, 12b) comprises a continuous electrically conductive path (17) provided along the length of the sleeve (12a) and extended along the substantial length of a corresponding side of said body (11), a conductive means (18) adapted to be in contact with the wrist of said wearer (28) and connected to said electrically conductive path (17) to form an electrical continuity path from said wearer (28) to said garment (10), and a plurality of conductive lines (19) horizontally extended from said electrically conductive path (17) across said body (11) in the vicinity of said wearer's buttock is pressed upon the seat of an electrostatic discharge (ESD) chair (21) when said wearer (28) is in sitting position.

### FIELD OF THE INVENTION

The present invention relates to an electrostatic discharge (ESD) garment designed as a grounding medium without a need for a ground cord which will lead to economical utility and effective usage of this unique technology.

### BACKGROUND OF THE INVENTION

The primary objectives of using an ESD smock are for contamination control and the shielding of any electrostatic field coming from the inner clothing of the wearer.

In an industrial manufacturing environment, it is not a practice to use a standard ESD smock as a grounding medium due to the lost or deteriorated electrical property after a certain number of wash (typically after 50 standard wash cycles). The washing will cause the black conductive lining to deteriorate in electrical property and over time, lead to failure in meeting the required electrical resistivity standard as practice in the electronics manufacturing industry.

U.S. Pat. No. 5,548,469 highlighted an ESD smock for grounding electrostatic charges. This prior art utilizes a dual-contact wrist-strap to drain static charges from the body through two ground paths. The charges are conducted through the sleeves by conductive ribbons sewn at the hems and are eventually grounded via a ground cord attached to the front table at the vicinity of the smock

ANSI/ESD S20.20 highlights the wrist-strap and ground cord system must be worn in sitting position regardless sitting on ESD or Non-ESD chair because the legs of an operator may be raised in certain sitting posture or position causing electrical discontinuity between the body of the operator and the floor ground.

However, such an ESD smock protection highlighted in U.S. Pat. No. 5,548,469 poses two major problems.

The first shortcoming is the using of the ground cord which needs to attach it to the smock at one end and at the front table at the opposite end while the production personnel is working. The ground cord restricts, especially in today's highly compact and multi-task work environment, the free movement of the worker which to some extend impede productivity. The hanging ground cord also increases the chances of work accidents.

The second shortcoming is that the cord requires a continuous ground monitor to guarantee grounding integrity and reliability. The cost of acquiring the ground monitoring equipment, its routine calibration, repair and maintenance cost will make the ground-cord grounding method an uneconomical static control undertaking.

There is a practical and industrial need to replace the ground-cord method with a more economical means yet able to guarantee grounding integrity and reliability. This led to further research to provide a more user friendly and economically feasible solution.

### SUMMARY OF THE INVENTION

Disclosed herewith is an unique method to effectively ground the static charge residing on the body of a wearer in a sitting position without the traditional use of a ground cord.

The invention consists of a specially designed ESD garment with unique features consist of the following:

The wrist-band is connected to the opening of the sleeve of a garment via a snap pin. This is to ensure electrical continuity between the body of the wearer and the garment. Alternatively, the sleeve of the garment can be fitted with a conductive cuff to make contact with the body in place of the wrist-strap.

Yet another option is to attach a conductive ribbon or plurality of conductive threads at the inner surface of the sleeve opening to impart electrical contact between the garment and the wrist of a wearer.

Yet another further option is any combination of the three (3) described above options to electrically connect the wearer's wrist to the ESD garment.

Therefore, there can be variation to that described in this embodiment without departing from the principal of this invention.

The opening of the sleeve and the sitting section of the garment is electrically connected by using conductive thread. The conductive thread is sewn along the inner hem of the sleeve and continues along the hem at the side of the garment body until the sitting region of the garment.

Parallel lines of conductive threads are horizontally sewn across the sitting section of the garment. Sewing of such parallel lines can be done with a standard double-threaded stitching method with one or both of the stitching threads to be conductive as to achieve electrical continuity in the stitch line(s). Other stitching method(s) may be used as long as to achieve electrical continuity in the stitch lines(s). AU parallel lines are electrically connected to facilitate an effective and reliable grounding network. The exposed surface of the sitting section of the garment will have stitch lines of dotted conductive spots or stitch lines of conductive dashes depending on whether the top thread is conductive or the bottom thread is conductive. Alternatively, both threads can be conductive.

When a wearer is sitting on the conductive chair, it is surprised to note that there is no difference in electrical resistance when taking the body-to-seat electrical resistance measurement amongst all three (3) configurations. It is also surprised to note that all three (3) configurations show no difference in electrical property in surface resistance of the exposed fabric surface when measured according to ANSI/ESD S20.20. This clearly concludes that the weight of a seated person will create excellent contact with the conductive chair to provide reliable and consistent electrical continuity to the ground. The word ‘conductive chair’ as used in this application denotes chairs designed for electrostatic discharge (ESD) protection which is typically wrapped with conductive polymer cover and fitted with conductive wheels resting on conductive flooring to provide electrical continuity and grounding.

By connecting the three embodiments above as one unique system, such invention will effectively drain static charge form the body to ground in sitting position. This is a unique and hassle-free low cost solution to eliminate the threat of static charge on the sitting bodies of the production personnel without the need of ground cord.

### BRIEF DESCRIPTION OF THE DRAWINGS

Other objects, features, and advantages of the invention will be apparent from the following description when read with reference to the accompanying drawings. In the drawings, wherein like reference numerals denote corresponding parts throughout the several views:

FIG. 1 illustrates the layout of a typical prior art;

FIG. 2a illustrates the layout of a preferred embodiment of an electrostatic discharge (ESD) garment of the present invention showing method of grounding ESD garment by using horizontally sewn conductive threads positioned at the sitting portion of the garment;

FIG. 2b shows the layout of an alternative embodiment of the ESD garment of the present invention;

FIG. 3 depicts a side view of a wearer with the electrostatic discharge garment in a sitting position on an ESD chair; and

FIGS. 4a to 4c show the cross sectional views of the stitch line(s) used in the present invention.

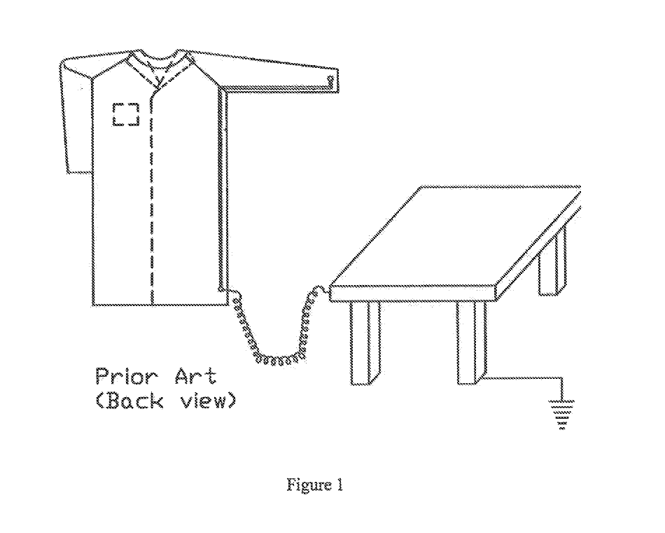

### DETAILED DESCRIPTION OF THE PREFERRED EMBODIMENTS

In the following detailed description, numerous specific details are set forth in order to provide a thorough understanding of the invention. However, it will be understood by those of ordinary skill in the art that the invention may be practiced without these specific details. In other instances, well-known methods, procedures and/or components have not been described in detail so as not to obscure the invention. Reference will now be made in detail to the preferred embodiments of the present invention, examples of which are illustrated in the accompanying drawings.

The word “conductive” described in the current invention means materials having the ability to conduct static electricity or static charge away when grounded. It includes either static dissipative (commonly defined as 1×105 to 1×1011 ohm) or electrical conductive (commonly defined as less than 1×105 ohm) materials. For the purpose of clarity, the word “conductive” is used throughout the current invention.

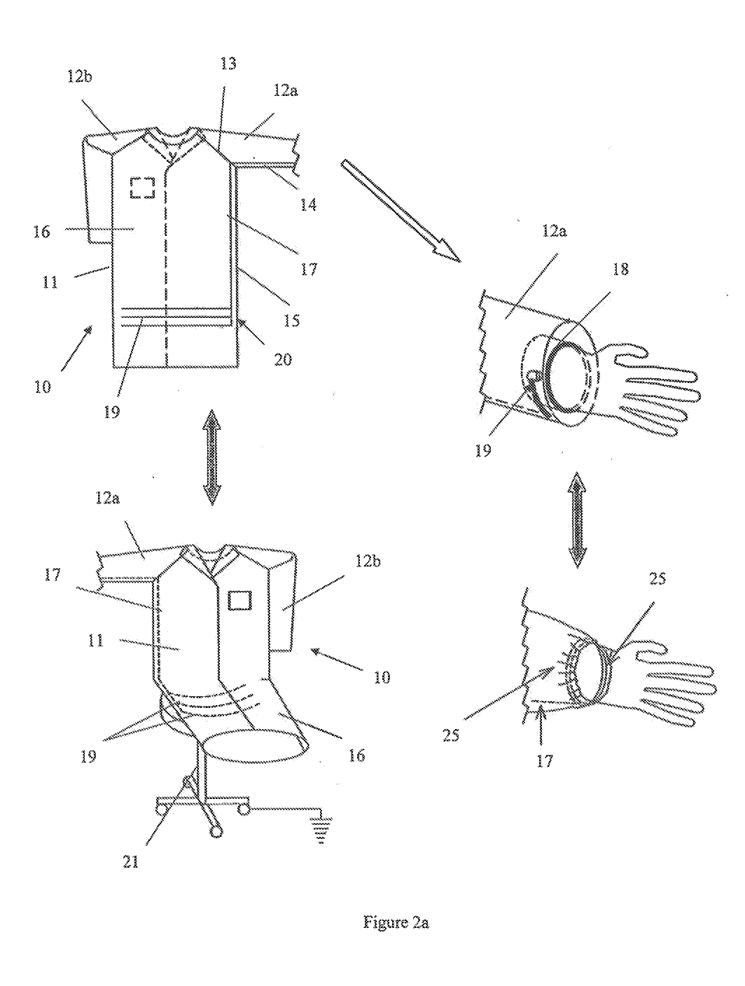

FIG. 2 shows the first embodiment of an electrostatic discharge (ESD) garment (10) constructed in accordance with the present invention. The garment (10) is in the form of a smock which is commonly used in the electronics and related industries. However, the garment (10) illustrated is solely for the purposes of illustration and it will be readily understood, the shape and style of the garment (10) can vary without departing from principles of the present invention.

The garment (10) includes a body (11) and a pair of sleeves (12a, 12b) that respectively connected to the body (11) at the seams (13. The sleeves (12a, 12b) are constructed from tubular configuration and seamed together at sleeve seams (14) respectively. The body (11) is also constructed generally from tubular configuration and seamed together at side seams (15) at both sides of the garment (10). The sleeve seams (14) and the side seams (15) are conventional seams sewn with sewing thread where the edges of the fabric (16) are folded over and sewn together to provide a sleeve hem and side hem respectively.

A continuous electrically conductive thread (17) is sewn onto the sleeve hem along the length of the sleeve seam (14) and extend onto the side hem of the body and continues further along the side seam (15) and terminated at an area (20) in the vicinity of the wearer's hip as shown in FIG. 2a. The conductive thread (17) used for the electrostatic discharge garment (10) of the present invention may be carbonized, metalized or carbon nanotube conductive thread. However, metalized conductive thread (17) is preferable due to the superior electrical contact capability and durability.

In one embodiment of the invention, the garment (10) is provided with a wrist-band (18) attached to the conductive thread (17) at one of the opened end of the sleeves (12a, 12b), where the wrist-band (18) is also made of conductive material so as to form the electrical continuity path from the body of the wearer (28) to the electrostatic discharge garment (10) worn by the wearer (28) as shown in FIG. 2a. There can be many variations to the wrist-band (18). Typically, the wrist-band (18) can be of expandable strap. Alternatively, it can be manufactured as adjustable straps. The material of construction of the wrist band (18) straps can be of conductive fibers, polymers metal or a combination thereof. The wrist band (18) is attached to the sleeve (12a) of the garment (10) in the form of a pin (19) formed by the male and female portions of a metal snap fastener. In operation, the pin (19) of the male and female portions will be snapped together to provide electrical continuity.

Alternatively, the opened ends of the sleeves (12a, 12b) can be formed with stretchable cuffs (not shown) which are made of electrical conductive material which fit tightly and comfortably around and in direct contact with the skin of the wrists of the wearer (28).

Yet another alternative is to attach a conductive ribbon or sewing a continuous rings or lining of conductive thread at the inner surface of the elastic opening (with grip design) of the sleeve so that such conductive lining will provide an excellent conductive surface to bridge (electrically) between the opening (25) of the sleeve and the wrist of a wearer when the ESD garment (10) is worn.

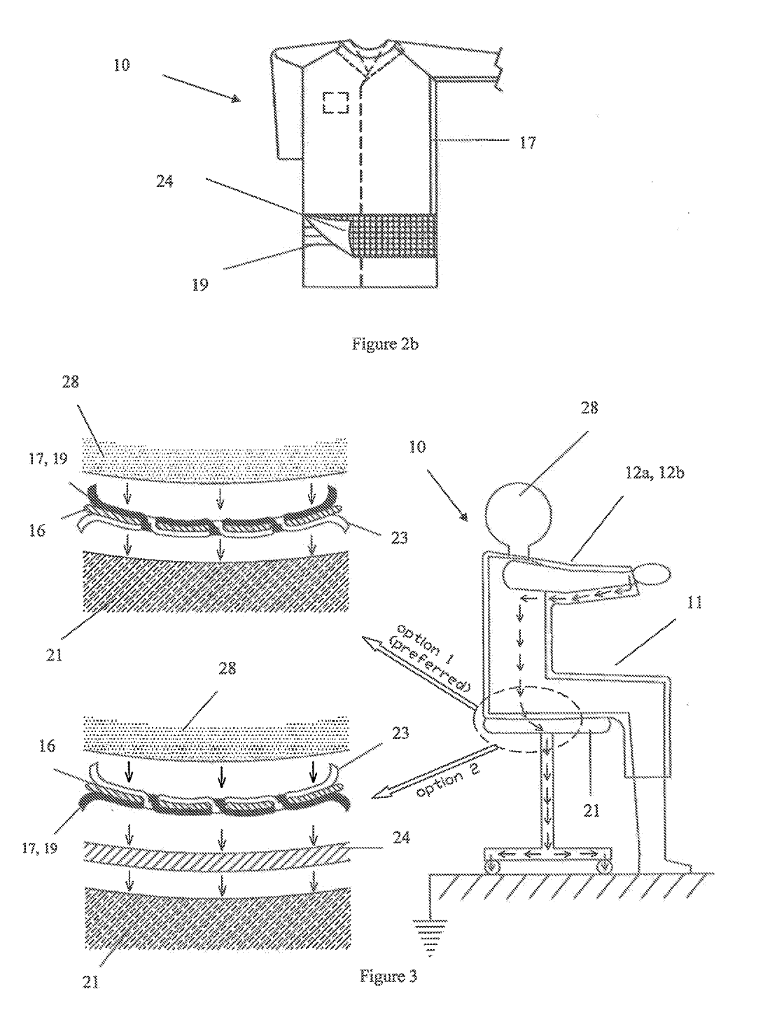

At the sitting region of the garment (10), a plurality of conductive lines (19) where each conductive line (19) is constructed by sewing a conductive thread horizontally across the body (11) of the garment (10) in the vicinity of the wearer's buttock area (20) is permanently attached onto the garment (10). Therefore, when the wearer (28) is in the sitting position, the horizontal conductive lines (19) at the wearer's buttock area will be pressed against the seat of an electrostatic discharge chair (21) as shown in FIG. 3.

To protect the stitched-on conductive thread from any possible physical damage and to impart lasting electrical property, a strip of ribbon (not shown) is sewn over its entire length starting from the sleeve opening at the wrist region, travels along the inner hem of the sleeve and further down the hem at the side of the garment (10) body until covers all the parallel lines in the sitting region of the garment (10). The strip of ribbon sewn on can be made from one or a combination of the following materials including fabric, plastic and rubber.

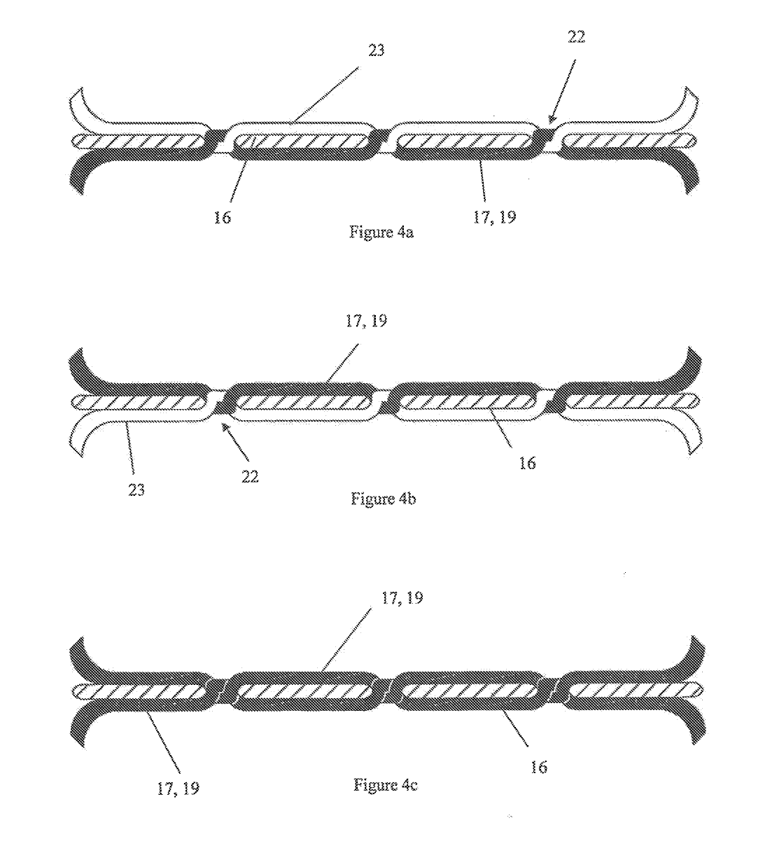

A close up sectional view of the conductive thread (17) sewn to the fabric (16) of the garment (10) is shown in FIGS. 4a to 4c. The sewing is preferably a double-threaded stitching where the configuration can be with the conductive dash lines facing inwards the human body while “small dots” facing outwards the exposed surface as shown in FIG. 4a or the conductive small dots facing inwards the human body while the conductive dash lines facing outwards the exposed surface as shown in FIG. 4b. However, the sewing could also be done with both threads conductive.

The most preferred embodiment is sewing with conductive thread (17) with the dash lines facing inwards the human body or wearer (28) while conductive small dots facing outwards the exposed surface as shown in FIG. 4a. This is because the conductive small dots as appeared in FIGS. 4a to 4c, is actually “hidden” slightly below the surface level of the fabric (16). The thinner the conductive thread, the more the small dots will “submerge” beyond the surface level of the fabric (16). This will provide better abrasive resistance due to less chance of surface contact during the more abrasive horizontal rubbing movement of the garment (10) in the everyday use. However, when the wearer sits, the vertical pressure from the body weight provides an excellent means to activate the electrical contact between the ESD garment (10) and the surface of an ESD chair, making such method of electrical connection simple and unique. Sewing with conductive thread with the dash lines facing inwards the human body will also to a great extend avoid possible ESD sparking due to accidental external contact especially with charged metal object. Sewing with conductive dash lines facing inwards the human body also protects the thread (17) from external contacts to maximize the electrical usage life of the ESD garment (10).

In other words, the pressure due to the weight of a person will effectively put the abundant tiny conductive thread dots in direct contact with the surface of the conductive seating (21). Such great quantity of tiny conductive dots created guarantee proper electrical contact and ensuring electrical continuity from the garment (10) to the conductive chair (21) as shown in FIG. 3. In this manner, there will be no need for an external grounding cord which comes with the associated problems mentioned earlier.

In another embodiment, if the conductive line (19) is constructed with the conductive thread sewn with the dash lines at the external surface of the fabric (16) of the garment (10), a standard ESD fabric with conductive grid-lines (24) could be attached at the area (20) in the vicinity of the wearer's buttock to protect the wear-and-tear of the exposed metallic conductive thread and to further eliminate the chances of microspark.

This invention allows static charge to be reliably conducted form the body through a unique ESD garment (10) to the conductive chair (21) in sitting position without the use of a ground cord or ground coil. Although this invention has been described in connection with specific forms and embodiment thereof, it will be appreciated that various modifications other than those discussed above may be resorted to without departing from the spirit and scope of the invention.

1. An electrostatic discharge garment (10) having a body (11) and a pair of sleeves (12a, 12b) comprising of: a continuous electrically conductive path (17) provided along the length of at least one sleeve (12a) and extended along the substantial length of a corresponding side of said body (11) to an area in the vicinity of a wearer's hip (28); a conductive means (18) adapted to be in contact with the wrist of said wearer (28) and connected to said electrically conductive path (17) to form an electrical continuity network from said wearer (28) to said garment (10); and a plurality of conductive lines (19) horizontally extended from said electrically conductive path (17) across said body (11) in the vicinity of said wearer's buttock is pressed upon the seat of an electrostatic discharge (ESD) chair (21) when said wearer (28) is in sitting position to form an electrical continuity network from said garment (10) of the wearer (28) to ground.

2. The electrostatic discharge garment (10) as claimed in claim 1, wherein said electrically conductive path (17) used for the garment (10) is a conductive thread sewn to the fabric (16) of the garment (10).

3. The electrostatic discharge garment (10) as claimed in claim 2, conductive thread (17) is a carbonized, metalized or carbon nanotube thread.

4. The electrostatic discharge garment (10) as claimed in claim 1, wherein said conductive means (18) is a conductive wrist-band (18) which could be an expandable strap or adjustable strap.

5. The electrostatic discharge garment (10) as claimed in claim 4, wherein said conductive wrist-band (18) is made of conductive fibers, polymers, metal or a combination thereof.

6. The electrostatic discharge garment (10) as claimed in claim 5, wherein said conductive wrist-band (18) is attached to said sleeve (12a) of the garment (10) in a form of a pin (19) formed by the male and female portions of a metal snap fastener.

7. The electrostatic discharge garment (10) as claimed in claim 4, wherein said conductive means (18) is a conductive ribbon or a continuous rings or lining of conductive thread at the inner surface of an elastic opening (25).

8. The electrostatic discharge garment (10) as claimed in claim 7, wherein said conductive ribbon is made of fabric, plastic strip, metallic or carbon nanotube material.

9. The electrostatic discharge garment (10) as claimed in claim 7, wherein said conductive thread is a carbonized, metalized or carbon nanotube thread.

10. The electrostatic discharge garment (10) as claimed in claim 1, wherein said conductive means (18) is a stretchable cuff which is made of electrical conductive material that encircling the wearer's wrist.

11. The electrostatic discharge garment (10) as claimed in claim 1, wherein said conductive lines (19) are sewn onto the fabric (16) of the garment (10), whereby the sewing is preferably a double-threaded sewing.

12. The electrostatic discharge garment (10) as claimed in claim 11, wherein said conductive lines (19) having a single conductive thread, are sewn with the conductive dash lines facing inwards said wearer (28) while small dots facing outwards the exposed surface.

13. The electrostatic discharge garment (10) as claimed in claim 11, wherein said conductive lines (19) having a single conductive thread, are sewn the conductive dash lines facing outwards and the small dots facing inwards the wearer (28).

14. The electrostatic discharge garment (10) as claimed in claim 13, wherein said garment (10) is further attached with a conductive gridded fabric (24) at the area (20) in the vicinity of the wearer's buttock.

15. The electrostatic discharge garment (10) as claimed in claim 11, wherein said conductive lines (19) having two conductive threads sewn onto the fabric (16) of the garment (10).

16. The electrostatic discharge garment (10) as claimed in claim 1, wherein said garment (10) is further provided with a strip of ribbon sewn over the entire length of said conductive path (17) and conductive lines (19) to protect them from possible damages.

17. The electrostatic discharge garment (10) as claimed in claim 16, wherein said strip of ribbon is made from one or a combination of fabric, plastic and rubber.
